(19) United States
(12) Patent Application Publication
(10) Pub. No.: US 2006/0005399 A1
(43) Pub. Date: Jan. 12, 2006

(54) Apparatus for interposition of edible planar strips

(76) Inventor: Larry A. Rast, Witchita, KS (US)

Correspondence Address: Rastar Corporation, Suite 310 MS 337, 11230 Gold Express Drive, Gold River, CA, 95670, US

(21) Appl. No.: 11/177,966

(22) Filed: Jul. 8, 2005

Related U.S. Application Data
(60) Provisional application No. 60/586,813, filed on Jul. 10, 2004.

(51) Int. Cl. B26B 3/00

(52) U.S. Cl. 30/302

(57) ABSTRACT

An apparatus for interposing planar strips of edible material within food articles, preferably prior to cooking. The planar strips preferably comprising cured or jerked meat products, such as bacon. The devices comprises a blade that is configured with a retention recess or aperture and a retention means. After aligning and attaching one or more edible planar strips to the blade apparatus it can be inserted within an article of food, such as within meat (i.e. a roast, beef, ham, lamb, turkey, chicken, fish, etc.) or other food article. The blade is then withdrawn leaving the edible planar strip still retained within the food article. Embodiment are also described having a means for ejecting the edible strip to allow interposing the strips without the need to fully pass the blade through the food article.

### CROSS-REFERENCE TO RELATED APPLICATIONS

This application is a claims priority from provisional patent application Ser. No. 60/586,813 filed Jul. 10, 2004 which is incorporated herein by reference and priority to which is claimed.

### STATEMENT OF FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

This invention pertains generally to kitchen utensils and more particularly to an apparatus and method for interposing strips of edible material, such as bacon, within foods such as meats.

2. Description of the Background Art

Historically to create succulent and juicy roasts and other meats, the chef has strove to retain the moisture, such as by injecting liquid or pulpy materials, by way of an injection needle into the meat. Although this method has provided value for increasing the fluid retention and flavor within the meat, it has a number of drawbacks. For example, when pulpy substances are injected the patron receiving the dish has no clue what the strange material is that is strewn through the meat. Furthermore the process provides no enhancement of the texture of the dish.

As can be seen, therefore, a need exists for the development of an apparatus and method for injecting recognizable and tasty additions to meats and other cooked foods.

The apparatus for interposition of edible planar strips in accordance with the present invention satisfies that need, as well as others, and overcomes deficiencies in previously known techniques of adding flavors and liquids to foods to be cooked.

### BRIEF SUMMARY OF THE INVENTION

The present invention provides a mechanism for interposing planar edible strips within food products, typically foods that are to be cooked. The interposition of the strips can be generally considered a form of injection, however, it does not suffer from the limitations of conventional injectors which require the material to be in a substantially liquid form.

The planar strip of edible material, such as bacon, is retained by a blade of the apparatus using any convenient means. By way of example and not limitation, the planar strip of edible material can be retained by a manually releasable clip wherein the strip is inserted through the food article and the clip then released by hand, allowing removal of the blade while leaving the planar strip of edible material. As a second example a one way retention mechanism can be utilized in which the planar strip is retained insofar as insertion progresses, and it automatically released upon withdrawal of the blade. This allows insertion of the planar strip into, without the need to insert the planar strip through the food article, therein providing additional flexibility, especially in large food articles. In a third example a release mechanism is coupled to the blade, wherein the planar strip is decoupled from the blade in response to activating the release, or activating the release in combination with withdrawal of the blade.

In one embodiment of the invention the blade portion is implemented to be from 8 to 20 inches in length. It will be appreciated that the length of the blade can be made longer or shorter without departing from the teachings of the present invention. Typically, however, the length of the blade, or blades, is formed to accommodate a given length of planar edible material. For example bacons strips come in lengths from approximately 8 inches to 16 inches. The width of the blade can be implemented to suit the width of the edible strips to be inserted into the edible food product.

One embodiment describes the use of a curved blade, or a bendable blade that can be formed into a curve and which retains its shape, therein allowing the bacon (or other strip) be inserted into a substantially planar food article, such as a fillet, wherein the blade can enter at a first position along the planar article and exit at a second position along the planar article.

In one embodiment the device is implemented as a reusable metal cooking tool, however, it can be alternatively implemented from inexpensive materials, such as plastic, for example as a disposable cooking item.

Further aspects and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a front plan view of the edible planar strip interposition apparatus according to an embodiment of the present invention, showing an elongated insertion element configured for receiving the edible planar strip, such as bacon.

FIG. 2 is a cross-section of the interposition element of FIG. 1, shown having a means for receiving the elongated edible strip according to an aspect of the present invention.

FIG. 3 is a cross-section of the tip of interposition element of FIG. 1, shown having a means for receiving the elongated and retention of edible strip according to an aspect of the present invention.

FIG. 4 is a front plan view of another embodiment of an edible planar strip interposition apparatus according to an aspect of the present invention.

FIG. 5 is a cross-section of the tip of interposition element of FIG. 4 according to an aspect of the present invention.

FIG. 6 is a front plan view of another embodiment of an edible planar strip interposition apparatus according to an aspect of the present invention, shown with a hollow or substantially hollow elongated interposition element.

FIG. 7 is a front plan view of another embodiment of an edible planar strip interposition apparatus according to an aspect of the present invention, shown with a recessed region for retaining edible planar strips.

FIG. 8 is a front plan view of another embodiment of an edible planar strip interposition apparatus according to an aspect of the present invention, showing a tip configured with a planar strip release mechanism.

FIG. 9 is a front plan view of the edible planar strip interposition apparatus of FIG. 8, showing an example of a release trigger mechanism within the handle of the planar strip release mechanism.

FIGS. 10A and 10B are plan views of forming the edible planar strip interposition apparatus, shown after forming a blank in FIG. 10A and after sharpening and handle forming in FIG. 10B.

FIGS. 11A and 11B are side views of an edible planar strip interposition apparatus having a hinged strip ejection mechanism according to an aspect of the present invention.

FIG. 12 is a side view of an edible planar strip interposition apparatus having a curved blade according to an aspect of the present invention.

### DETAILED DESCRIPTION OF EMBODIMENT(S)

Referring more specifically to the drawings for illustrative purposes, the present invention is embodied in the method generally described in FIG. 1 to FIG. 12. The following description is presented to enable one of ordinary skill in the art to make and use the invention as provided in the context of a particular application and its requirements. Unnecessary technical details, which extend beyond the necessary information allowing a person of ordinary skill in the art to practice the invention, are preferably absent for the sake of clarity and brevity. Furthermore, it is to be understood that inventive aspects may be practiced in numerous alternative ways by one or ordinary skill without departing from the teachings of the invention. Therefore, various modifications to the preferred embodiments will be readily apparent to those skilled in the art, and the principles defined here may be applied to other embodiments. Thus the present invention is not intended to be limited to the embodiments shown, but is to be accorded the widest scope consistent with the principles and novel features disclosed herein.

Throughout the specification numerous values and type designations may be provided for the elements of the invention in order that a complete, operable, embodiment of the invention be disclosed. However, it should be understood that such values and type designators are merely representative and are not critical unless specifically so stated. The scope of the invention is not limited to one or more specific exemplifications within a described embodiment.

The present system and method may be implemented in a number of ways, however, the following is limited to descriptions of one or more preferred embodiments of the invention that may be readily practiced and easily understood. It should be appreciated, however, that one of ordinary skill in the art can modify these embodiments, especially in view of the teachings found herein, to implement a number of variations on the embodied invention without the need for creative effort and without departing from the teachings of the invention as described and/or claimed.

FIG. 1-3 illustrates by way of example and embodiment of edible planar strip interposition apparatus 10 having a handle 12 coupled to an elongated insertion element 14, hereafter referred to as blade 14, configured for receiving the edible planar strip. Handle 14 comprises a body 16 with sides 18, preferably tapering to sharp edges 19 thereby reduces the forces required for inserting apparatus 14 into a food item, such as a cut of meat. A distal end of blade 14 terminates in a tip 20 which is also configured to simplify the insertion of the blade into a food item, such as being tapered to a sharp point as shown.

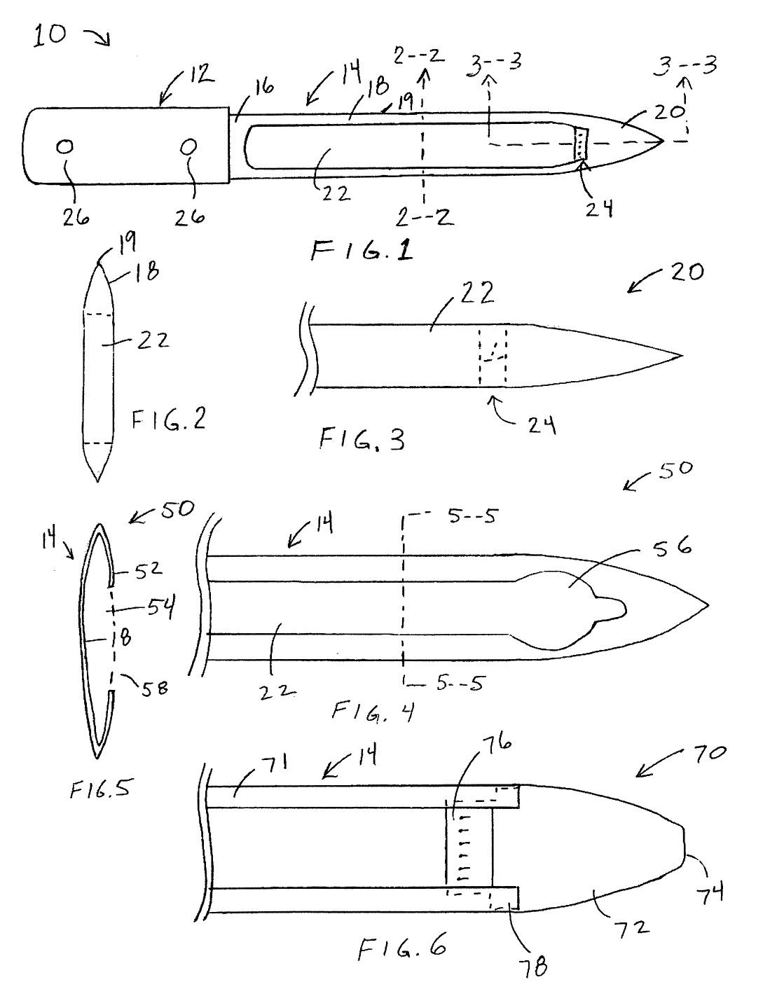

FIG. 2 and FIG. 3 show cross sections of apparatus 10, as seen at a cross section of blade 14 in FIG. 2, and a cross-section through tip 20 in FIG. 3.

It should be appreciated that tip 20 preferably terminates in a single point or as a sharp line as shown in FIG. 6. Tip 20 is preferably symmetrical with blade 14, wherein the apparatus can be more readily inserted straight-through a food item. However, the tip may be asymmetrical to provide curvature through the insertion, and may be coupled with the use of a curved blade.

A means for receiving a planar strip of edible material 22 can be implemented as a hollow, recess, or aperture, of a size sufficient for receiving the planar strip of edible material. In FIG. 1 the receiving means comprises an aperture 22 into which the planar strip is retained during the interposition process. The intent of receiving means 22 is to prevent the application of undue forces on the edible strip of planar material which operate opposing the motion of insertion. It should be readily appreciated that unless these forces are mitigated by protecting the edible strip, the strip can tear during insertion thereby preventing proper interposition of the strip at the desired location in the food items.

A means for retaining the edible planar strip 24 is coupled to blade 14 near the distal end, for retaining an end portion of the edible strip during the interposition process. One embodiment of retention means 24 comprises protrusions which are pressed into the edible material prior to insertion of blade 14 into a food article. The edible material may be removed from the protrusions once tip 20 extends sufficiently through the edible food material. Other forms of retention means may be alternatively implemented, such as clips, slots, wrap posts, and other convenient mechanisms and combination of mechanisms for retaining an end of an edible planar food strip, such as bacon, to blade 14.

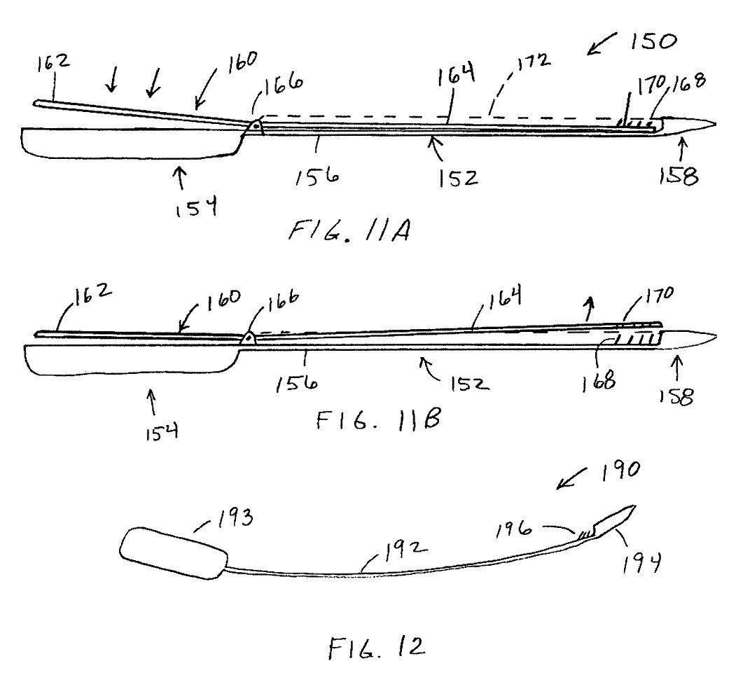

A handle 12 is shown coupled to blade 14 utilizing fasteners 26, although it can be fastened using any convenient method, one-piece handle, molded, adhesives, and so forth. Furthermore, having a handle with a comfortable grip profile (cross-section), such as round, rounded-square, oval, and so forth, is optional as a section of blade 14, preferably without sharp edges 19 can be utilized as the handle. For example if 14 is formed from metal, then extended sections (wings) of blade 14 can be bent to form a handle (seen in FIGS. 10A and 10B). As the apparatus is intermittently utilized there is little necessity for an extraordinarily comfortable handle as found on chefs knives, although the handle can be implemented in that manner.

FIGS. 4 and 5 illustrate by way of example an embodiment of an edible planar strip interposition apparatus 50 having a blade 14 formed in a substantially hollow cross-section with retention lip structures 52. The elongated edible planar strip is retained within the hollow 54, the end of which may be augmented with an optional means of planar strip retention, such as the protrusion shown in FIG. 1, or other means of retaining the strip. As the planar strip is largely surrounded in this embodiment it is not generally necessary to retain the strip using a clip or other additional retention devices. An optional removal aperture 56 is shown to facilitate removal of the strip from blade 14. It should be appreciated that the strip can be removed by other means, such as a removable tip and so forth, wherein the strip is retained interposed within the food item while blade 14 is removed. The hollow 54 may be configured for partially surrounding the edible strip of material, or with a fully surrounding blade 58, from which the strip is slid after insertion through the food article.

FIG. 6 illustrates by way of example an embodiment 70 having a means for receiving the planar strip, such as a hollow or recess. In this embodiment a slotted hollow is created from formed edges 71 encircling a portion of the strip retention area. The tip 72 is shown with a non-pointed tip, although it is preferably formed with a sharp edge to facilitate insertion into food items. Tip 72 is also optionally configured with a strip retention means 74 and with removable retention structure 76 allowing it to be retained or removed from the distal end of blade 14, such as to facilitate removal of the planar strips, cleaning of the blade, or a combination thereof.

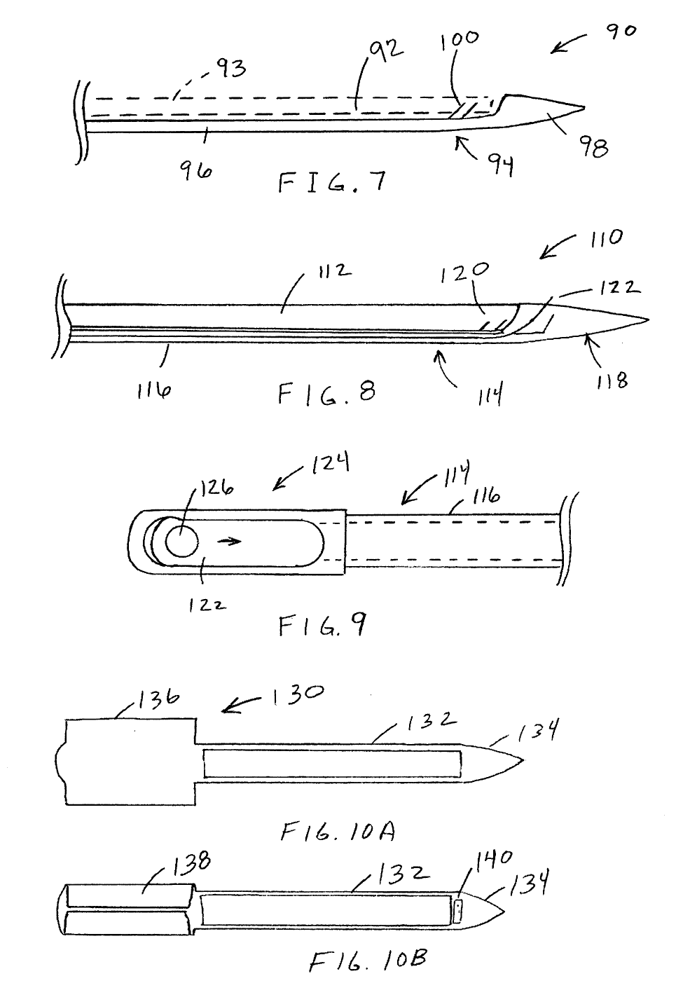

FIG. 7 illustrates by way of example an embodiment of an edible planar strip interposition apparatus 90 having a recess 92 into which the planar strip 93 (in phantom) is retained. The blade 94 has a body 96 coupled to a tip 98 having a sufficient width to protect strip 93 during insertion. A means 100 for retaining strip 93 is shown, such as protrusions shown angled toward tip 98. It should also be appreciated that protrusions can extend along the entire length of blade 94 if desired, as this can aid in retaining the strip all along its length and preventing tearing. It should be appreciated that this distributed form of retention device may also be utilized within the other embodiments described herein, or implemented with teachings provided herein, without departing from the present invention. The use of angled protrusions facilitate the removal of blade 94 as the interposition apparatus is retrieved from a food item, such as from a meat item. Alternatively, other forms of retention device may be utilized at the distal end of blade 94, other portions of blade 94, or distributed along blade 94. This embodiment does not have an movable strip ejection mechanism, however, in some instances the edible strip will automatically disengage from blade 94 upon withdrawing blade 94 from the food article, therein leaving the edible strip interposed within the food article.

FIG. 8 illustrates by way of example an embodiment of an edible planar strip interposition apparatus 110 comprising a recess 112 in blade 114 having body 116. The tip 118 is shown of similar construction to FIG. 7. A retention means 120 is shown for retaining an edible planar strip of material in recess 112, which could be alternatively formed as a hollow, aperture, or other configuration suitable for retaining the strip.

An ejection member 122 is shown in this embodiment slidably engaged within a groove of blade 114 for facilitating the removal of the edible strip from the apparatus. Preferably, the ejection mechanism displaces a sufficient amount of the planar material from the path of the apparatus, wherein upon removal of the apparatus the strip will remain in place. The use of an ejection mechanism allows the device to be used for inserting planar strips which do not extend through a food article, but which simply extend into the food article. In this example embodiment, ejection member 122 is preferably formed from a flexible strip of stiff material, such as metal or plastic of sufficient thickness, wherein the tip can exert a pressure to release the tip of the planar strip from the retention means 120.

FIG. 9 depicts one embodiment of a handle having a trigger mechanism for controlling ejection member 122. A handle 124 is shown with a slidably engaged ejection element 122 having a manual interface 126, such as an aperture for finger insertion, or protrusion for grasping. The application of force to interface 126 applies a force to at least one end of the edible strip to facilitate it's release from the apparatus. It should be appreciated that other forms of ejection can be implemented, such as having the strip apply an ejection force all along the length of the blade to force the planar material away from the blade so that the interposition apparatus can be withdrawn while leaving the strip retained within the food article. This can be accomplished for example by retaining a slidable strip on angle pins, in a similar manner to the angles on the retention pin structures, wherein sliding the ejection mechanism toward the tip causes a displacement of the strip in the direction of the planar strip therein forcing it to the side of the blade. A rotating member may also be utilized for ejecting the strip (i.e. as in FIG. 11). Other forms can be derived by those of ordinary skill in the art, such as a pneumatic embodiment in which a pump fills a bladder whose expansion ejects the strip for retention in the food article while the blade is being withdrawn.

FIGS. 10A and 10B depict an example of forming the edible strip interposition apparatus 10 from a single piece of metal 130 having a blade portion 132 with tip portion 134 and handle portion 136. The blank 130 may be formed by any convenient process, such as by stamping, laser cutting, molding and so forth. The blade and tip are then preferably ground to a sufficiently sharp edge (or preformed with the sharp edge) and the handle is bent to form a 3-D handle 138, preferably having a rounded cross-section. A means 140 for retaining the edible strip is shown attached near the distal end, tip 134, to properly retain the edible strip. It should also be appreciated that the apparatus may be formed by injection molding or other means of working thermoformed plastics, or other moldings of resins or polymers of sufficient rigidity for insertion through food articles such as meats.

FIGS. 11A and 11B depicts another embodiment 150 of the strip interposition apparatus which uses a hinged release mechanism for blade 152. The proximal end of blade 152 is shown extending from handle 154 formed of a stiff material 156, such as aluminum or more preferably a form of steel, extending to sharp tip 158. An ejection handle 160 is shown formed with a handle end 162 coupled to an elongated blade end 164 and pivoting from a pivot point, or axle, or other rotatable element 166. A retention means near the tip of blade 152 is preferably configured for release in response to movement of handle 162 which rotates blade section 164 through pivot 166. Optionally, the blade portion 152 may be formed with a recess, channel, or aperture, depicted by sides 172 (shown by dashed lines) into which the edible strip is retained until acted upon by the ejection means, such as handle 162 and elongated section 164.

In this embodiment the retention means is shown comprising retention pins 168 extending from blade material 156 through apertures 170 in blade end 164. As seen in the progression from FIG. 11A to FIG. 11B, when pressure is applied to handle 162 of apparatus 150, the elongated end 164 pivots about 166 to release the edible strip from pins 168 and thereby allow the apparatus to be withdrawn from the food article without the need to manually hold the end of the edible planar strip, such as holding it after it has been extended through the food article. It will be appreciated that this method depicts another form of ejecting the edible planar strip from the interposition apparatus, without the necessity of first passing the tip of the apparatus all the way through the food article into which the edible planar strip are to be retained.

FIG. 12 depicts an interposition apparatus 190 having a curved blade 192 with tip 194, retention means 196 and handle 198. It should be appreciated that the curved blade allows for interposition of strips with substantially planar articles of food, such as filets and the like, without the need to run the blade all the way through the food article. It should also be appreciated that is aspect of the invention, as well as the other aspects described, can be implemented separately or in combination with other aspects described herein to form embodiment according to the teachings of the invention.

A number of different embodiments have been described by way of implementing the present invention, it should be appreciated, however, that these are provided by way of example only and that other embodiments may be created by one of ordinary skill in the art from the teachings found herein, without departing from the present invention.

Other embodiments of the invention are contemplated which can provide additional combination functionality. For example a blade formed with an aperture 22 like in FIG. 1, can have a sharp cutting edge on the side, wherein it can be used somewhat conventionally as a knife. By making the interior side of the second side with a sharp cutting edge the device can also be utilized as a cheese knife, the thin sections of metal preventing the sticking of the cheese over a large surface easing cutting. The handle may incorporate other utensils, such as a cheese grater, a garlic press, tools for making decorative vegetables and the like. It will be appreciated that other combinations can be formed according to these teachings.

The aspects, modes, embodiments, variations, and features described are considered beneficial to the embodiments described or select applications or uses; but are illustrative of the invention wherein they may be left off or substituted for without departing from the scope of the invention. Preferred elements of the invention may be referred to whose inclusion is generally optional, limited to specific applications or embodiment, or with respect to desired uses, results, cost factors and so forth which would be known to one practicing said invention or variations thereof.

Moreover, an edible planar material interposition device according to the various embodiments of the invention may be provided with all of features described herein, or only portions thereof, which combinations may be practiced and/or sold together or separately. For example, an edible planar material interposition device may be manufactured and sold without certain desired equipment, or for later assembly.

It should be appreciated that each aspect of the invention may generally be practiced independently, or in combinations with elements described herein or elsewhere depending on the application and desired use. Modes may be utilized with the aspects described or similar aspects of this or other devices and/or methods. Embodiments exemplify the modes and aspects of the invention and may include any number of variations and features which may be practiced with the embodiment, separately or in various combinations with other embodiments.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

We claim:

1. An apparatus for interposing planar edible strips within food articles, comprising:
a handle configured for grasping;
a blade joined to said handle and configured for insertion into or through a given food article;
wherein said blade has a proximal end joined to said handle and a distal end being sufficiently sharp to insert into or through the given food article;
a channel, groove, recess or aperture within said blade configured for receiving at least one planar edible strip for insertion into or through the given food article; and
means for retaining the planar edible strip in said channel, groove, recess or aperture during insertion into the given food article wherein said planar edible strip is interposed within the food article after withdrawing said blade from the given food article.

2. An apparatus as recited in claim 1, wherein said blade is metallic.

3. An apparatus as recited in claim 1, wherein said blade is formed from a thermoplastic or resin of sufficient rigidity to insert into or through a given food article.

4. An apparatus as recited in claim 1, wherein said channel, groove, recess or aperture in said blade into which the planar edible strip is held, is of sufficient depth for retaining the planar edible strip during insertion into the given food article without breakage of the planar edible strip.

5. An apparatus as recited in claim 1, wherein said means for retaining a planar edible strip is configured for retaining a strip of meat.

6. An apparatus as recited in claim 1, wherein said means for retaining a planar edible strip is configured for retaining a strip of cured meat, or jerkied meat.

7. An apparatus as recited in claim 1, wherein said means for retaining a planar edible strip is configured for retaining a strip of bacon.

8. An apparatus as recited in claim 1, wherein said means for retaining the planar edible strip comprises protrusions which extend sufficiently from said blade to retain the edible strip of material.

9. An apparatus as recited in claim 1, wherein said means for retaining the planar edible strip comprises strip retention clip configured for grasping a portion of the edible strip of material.

10. An apparatus as recited in claim 1, further comprising means of disengaging said planar edible strip from said retention clip.

11. An apparatus as recited in claim 10, wherein said means of disengaging comprises a release mechanism which can be controlled proximal to said handle.

12. An apparatus as recited in claim 10, wherein said means of disengaging comprises a slidable ejection element configured to apply pressure to the given edible strip to sufficiently displace it from said blade so that upon withdrawing said blade from the given article of food, the edible strip remained interposed within the given article of food.

13. An apparatus as recited in claim 10, wherein said means of disengaging comprises a rotatable ejection element configured to apply pressure to the given edible strip to sufficiently displace it from said blade so that upon withdrawing said blade from the given article of food, the edible strip remained interposed within the given article of food.

14. An apparatus as recited in claim 1, wherein said blade is configured to be at least partially hollowed out for receiving the edible planar strip.

15. An apparatus for interposing edible strips into food articles, comprising:
a handle configured for grasping;
a blade joined to said handle and configured for insertion into or through a given food article;
wherein said blade has a proximal end joined to said handle and a distal end being sufficiently sharp to insert into or through the given food article;
a channel, groove, recess or aperture within said blade configured for receiving at least one meat strip for insertion into or through the given food article; and
a meat strip retention clip.

16. An apparatus as recited in claim 15, further comprising a mechanism for displacing the edible strip from the channel, groove, recess or aperture in said handle in response to activation.

17. An apparatus as recited in claim 15, wherein said blade is configured to be at least partially hollowed out for receiving the edible planar strip.

18. An apparatus as recited in claim 15, wherein said blade comprises a curves section of material configured for receiving the edible planar strip.

19. A method of injecting planar strips of edible materials into food articles, comprising:
aligning a planar strip of edible material within a channel of an insertion blade;
attaching the planar strip to a retention mechanism coupled to said insertion blade;
driving said insertion blade into an article of food;
releasing the planar strip; and
withdrawing said insertion blade while leaving the planar strip lodged in the article of food.

20. A method as recited in claim 19:
wherein said releasing of the planar strip occurs in response to withdrawal of the insertion blade;
wherein said releasing is performed in response to activation of a release mechanism; and
wherein said releasing is performed in response to sliding activation or rotatable activation of a release mechanism.
